(19) United States
(12) Patent Application Publication
(10) Pub. No.: US 2019/0039559 A1
(43) Pub. Date: Feb. 7, 2019

(54) INFLATION GAS DEFLECTOR FOR AUTOMOTIVE AIRBAG ASSEMBLY

(71) Applicant: Unifrax I LLC, Tonawanda, NY (US)

(72) Inventor: Kenneth B. MILLER, Lockport, NY (US)

(21) Appl. No.: 16/155,320

(22) Filed: Oct. 9, 2018

Related U.S. Application Data
(63) Continuation of application No. 15/299,414, filed on Oct. 20, 2016.
(60) Provisional application No. 62/245,995, filed on Oct. 24, 2015.

(51) Int. Cl. B60R 21/264; B60R 21/276; B60R 21/231; B60R 21/235; B60R 21/20; B60R 21/272

(52) U.S. Cl. CPC B60R 21/2646; B60R 21/276; B60R 21/231; B60R 21/235; B60R 2021/23514; B60R 21/272; B60R 2021/23123; B60R 2021/23509; B60R 21/20

(57) ABSTRACT

Disclosed is an inflation gas deflector for an automotive airbag assembly. The inflation gas deflector includes at least one layer of inorganic platelets or a multiple layer composite of at least one support layer and at least one inorganic platelet layer carried by the support layer. Also disclosed is an airbag cushion incorporating the inflation gas deflector and an automotive airbag assembly including the inflatable airbag cushion, the inflation gas deflector, and an inflator.

This application is a continuation of U.S. Ser. No. 15/299,414, filed Oct. 20, 2016, which claims the benefit of the filing date under 35 U.S.C. § 119(e) from United States Provisional application For Patent Application Ser. No. 62/245,995, filed on Oct. 24, 2015, which is incorporated by reference in its entirety.

### TECHNICAL FIELD

The present disclosure generally relates to inflatable automotive airbag assemblies or systems. More particularly, the present disclosure relates to automotive airbag cushions and airbag assemblies that include inflation gas deflectors that protect the airbag cushion.

### BACKGROUND

An airbag is an inflatable cushion that is designed to protect automobile occupants from serious injury in the event of a collision. A typical airbag system includes a module containing an inflatable air bag and an inflator. In the event of a collision of a certain magnitude crash sensors activate the inflation of the airbag. The crash sensors are designed to prevent inflation of the airbag in response to the automobile traversing bumps and potholes in the roadway, or in the event of minor automobile collisions.

Inflation of the airbag may occur through the release of a pressurized inert gas from a source of pressurized gas that is contained within the airbag module. The airbag may also be inflated through the generation of a gas resulting from a source of solid chemical generant or propellant contained within the airbag module activated by an ignitor. The sources of pressurized gas and/or propellant are contained within separate vessels within the airbag module.

In some instances, the airbag module may contain both a source of pressurized inert gas and a source of solid chemical propellant for generating an inflation gas. According to this design, in response to a collision, the pressurized gas is first released from its vessel followed by the generation of a second gas from the ignited chemical reaction of the source of solid chemical propellant to expand the volume of the released first inert gas.

To protect the safety of the occupants from injury, the airbag cushion must be inflated to the proper level within the desired period of time. If the pressurized inert gas or the gas generated from the solid propellant is not directed in the correct direction from the inflator unit toward the inflatable portion of the airbag, the airbag cushion may be improperly inflated and/or the airbag assembly may be damaged.

### SUMMARY

Disclosed is an inflation gas deflector for an automotive airbag cushion, said inflation gas deflector comprising an inorganic platelet layer.

According to certain illustrative embodiments, the inflation gas deflector for an automotive airbag cushion, said inflation gas deflector comprising a support layer and an inorganic platelet layer.

Additionally disclosed is an airbag cushion comprising a cushion portion defining an inflation cavity and an inflation gas deflector attached to the cushion portion, said inflation gas deflector comprising an inorganic platelet layer.

According to certain illustrative embodiments, the airbag cushion comprises a cushion portion defining an inflation cavity and an inflation gas deflector attached to the cushion portion, said inflation gas deflector comprising a support layer and an inorganic platelet layer.

According to certain illustrative embodiments, the airbag cushion comprises a base portion having an opening with which an inflator for delivering an inflation gas into said airbag can be coupled, a cushioning portion attached to said base portion, said base portion and cushioning portion defining an inflation cavity, and an inflation gas deflector attached to the base portion of the airbag cushion, said inflation gas deflector comprising a support layer and an inorganic platelet layer.

Additionally disclosed is an airbag cushion comprising a base portion having an opening with which an inflator for delivering an inflation gas into said airbag can be coupled, a cushioning portion attached to said base portion, said base portion and cushioning portion defining an inflation cavity, and an inflation gas deflector attached to the base portion of the airbag cushion, said inflation gas deflector comprising a support layer and an inorganic platelet layer. According to certain embodiments, the inflation gas detector is positioned between said base portion and said cushioning portion of said airbag cushion. According to certain embodiments the inflation gas detector is attached or connected to an inner surface of the base portion of the airbag cushion.

Further disclosed is an airbag assembly comprising an airbag cushion defining an inflation cavity, an inflation gas deflector attached to said airbag cushion, said inflation gas deflector comprising an inorganic platelet layer, and an inflator in communication with said airbag cushion and configured to deliver an inflation gas to said airbag cushion. According to certain embodiments the inflation gas detector is attached or connected to an inner surface of the airbag cushion.

According to certain illustrative embodiments, the airbag assembly comprises an airbag cushion defining an inflation cavity, an inflation gas deflector attached to said airbag cushion, said inflation gas deflector comprising a support layer and an inorganic platelet layer, and an inflator in communication with said airbag cushion and configured to deliver an inflation gas to said airbag cushion. According to certain embodiments the inflation gas detector is attached or connected to an inner surface of the airbag cushion.

According to certain illustrative embodiments, the airbag assembly comprising an airbag cushion comprising a base portion having an opening with which an inflator for delivering an inflation gas into said airbag cushion can be coupled, a cushioning portion attached to said base portion, said base portion and cushioning portion defining an inflation cavity, and an inflation gas deflector attached to the base portion, said inflation gas deflector comprising an inorganic platelet layer, and an inflator in communication with said airbag cushion and configured to deliver an inflation gas to said airbag cushion. According to certain embodiments the inflation gas detector is attached or connected to an inner surface of the airbag cushion.

According to certain illustrative embodiments, the airbag assembly comprising an airbag cushion comprising a base portion having an opening with which an inflator for delivering an inflation gas into said airbag cushion can be coupled, a cushioning portion attached to said base portion, said base portion and cushioning portion defining an inflation cavity, and an inflation gas deflector attached to the base portion, said inflation gas deflector comprising a support layer and an inorganic platelet layer, and an inflator in communication with said airbag cushion and configured to deliver an inflation gas to said airbag cushion. According to certain embodiments the inflation gas detector is attached or connected to an inner surface of the airbag cushion.

According to certain illustrative embodiments, the airbag assembly comprises an airbag cushion comprising a base portion having an opening with which an inflator for delivering an inflation gas into said airbag can be coupled, a cushioning portion attached to said base portion, said base portion and cushioning portion defining an inflation cavity, and an inflation gas deflector attached to the base portion, said inflation gas deflector comprising an inorganic platelet layer, and an inflator having at least one gas exit port in fluid communication with said inflation cavity of said airbag cushion. According to certain embodiments, the inflation gas detector is positioned between said base portion and said cushioning portion of said airbag cushion. According to certain embodiments the inflation gas detector is attached or connected to an inner surface of the base portion of the airbag cushion.

According to certain illustrative embodiments, the airbag assembly comprises an airbag cushion comprising a base portion having an opening with which an inflator for delivering an inflation gas into said airbag can be coupled, a cushioning portion attached to said base portion, said base portion and cushioning portion defining an inflation cavity, and an inflation gas deflector attached to the base portion, said inflation gas deflector comprising a support layer and an inorganic platelet layer, and an inflator having at least one gas exit port in fluid communication with said inflation cavity of said airbag cushion. According to certain embodiments the inflation gas detector is attached or connected to an inner surface of the base portion of the airbag cushion.

Further disclosed is an airbag assembly comprising an airbag cushion comprising a base portion having an opening with which an inflator for delivering an inflation gas into said airbag can be coupled, a cushioning portion attached to said base portion, said base portion and cushioning portion defining an inflation cavity, and an inflation gas deflector attached to the base portion, said inflation gas deflector comprising an inorganic platelet layer, an inflator having at least one gas exit port in fluid communication with said cavity of said airbag cushion, and a housing coupled with said inflator and packaging said airbag cushion. According to certain embodiments the inflation gas detector is attached or connected to an inner surface of the base portion of the airbag cushion.

Further disclosed is an airbag assembly comprising an airbag cushion comprising a base portion having an opening with which an inflator for delivering an inflation gas into said airbag can be coupled, a cushioning portion attached to said base portion, said base portion and cushioning portion defining an inflation cavity, and an inflation gas deflector attached to the base portion, said inflation gas deflector comprising a support layer and an inorganic platelet layer, an inflator having at least one gas exit port in fluid communication with said cavity of said airbag cushion, and a housing coupled with said inflator and packaging said airbag cushion. According to certain embodiments, the inflation gas detector is positioned between said base portion and said cushioning portion of said airbag cushion. According to certain embodiments the inflation gas detector is attached or connected to an inner surface of the base portion of the airbag cushion.

### BRIEF DESCRIPTION OF THE DRAWINGS

FIG. 1 is a schematic cross-sectional view of an illustrative embodiment of the multiple layer inflation gas deflector for an automotive airbag cushion.

FIG. 2 is a schematic cross-sectional view of another illustrative embodiment of the multiple layer inflation gas defector for an automotive airbag cushion.

FIG. 3. is a schematic cross-sectional view of another illustrative embodiment of the multiple layer inflation gas defector for an automotive airbag cushion.

FIG. 4 is a schematic cross-sectional view of another illustrative embodiment of the multiple layer inflation gas defector for an automotive airbag cushion.

FIG. 5 shows an exploded perspective view of an illustrative embodiment of the inflatable airbag cushion.

FIG. 6 shows an exploded perspective view of the airbag assembly.

FIG. 7 shows a perspective view one illustrative embodiments of a side curtain airbag assembly configured for installation in a vehicle door.

FIG. 8 shows a rear view of an illustrative embodiment of a side curtain airbag.

FIG. 9 shows a side view of the side curtain airbag of FIG. 8.

### DETAILED DESCRIPTION

Disclosed in an inflation gas deflector for an airbag cushion for an automotive airbag assembly. The inflation gas deflector comprises at least one layer of inorganic platelets. According to certain illustrative embodiments, the inflation gas deflector comprises more than one layers of inorganic platelets. According to certain illustrative embodiments, the inflation gas deflector may comprise at least one support layer and at least one inorganic platelet layer. The at least one inorganic platelet layer is carried by the at least one support layer. According certain illustrative embodiments, the inflation gas deflector may comprise one support layer and one inorganic platelet layer carried by the one support layer. According certain illustrative embodiments, the inflation gas deflector may comprise more than one support layer and one inorganic platelet layer carried by the multiple layer support layer. According certain illustrative embodiments, the inflation gas deflector may comprise more than one support layer and more than one inorganic platelet layer carried by the multiple layer support layer.

The airbag cushion comprises a cushion portion defining an inflation cavity to receive an inflation gas from an inflator and an inflation gas deflector comprising at least one inorganic platelet layer that is attached to the cushion portion. The inflation gas deflector may be attached of the inner surface of the cushion portion. According to certain illustrative embodiments, the inflation gas deflector comprises more than one layers of inorganic platelets. According to certain illustrative embodiments, the inflation gas deflector may comprise at least one support layer and at least one inorganic platelet layer. The at least one inorganic platelet layer is carried by the at least one support layer. According certain illustrative embodiments, the inflation gas deflector may comprise one support layer and one inorganic platelet layer carried by the one support layer. According certain illustrative embodiments, the inflation gas deflector may comprise more than one support layer and one inorganic platelet layer carried by the multiple layer support layer. According certain illustrative embodiments, the inflation gas deflector may comprise more than one support layer and more than one inorganic platelet layer carried by the multiple layer support layer.

According to certain illustrative embodiments, the airbag assembly comprises an airbag cushion defining an inflation cavity, an inflation gas deflector attached to the airbag cushion, and an inflator in communication with the airbag cushion and configured to deliver an inflation gas to the airbag cushion. According to certain embodiments the inflation gas detector is attached or connected to an inner surface of the airbag cushion. The inflation gas deflector may be attached of the inner surface of the cushion portion between the inflator and the inner surface of the airbag cushion. According to certain illustrative embodiments, the inflation gas deflector comprises more than one layers of inorganic platelets. According to certain illustrative embodiments, the inflation gas deflector may comprise at least one support layer and at least one inorganic platelet layer. The at least one inorganic platelet layer is carried by the at least one support layer. According certain illustrative embodiments, the inflation gas deflector may comprise one support layer and one inorganic platelet layer carried by the one support layer. According certain illustrative embodiments, the inflation gas deflector may comprise more than one support layer and one inorganic platelet layer carried by the multiple layer support layer. According certain illustrative embodiments, the inflation gas deflector may comprise more than one support layer and more than one inorganic platelet layer carried by the multiple layer support layer.

According to certain embodiments, the airbag cushion comprises a base portion having an opening with which an inflator for delivering an inflation gas into the airbag is coupled. The airbag cushion also includes a cushioning portion that is attached to the base portion of the airbag cushion. The base portion and cushioning portion of the airbag cushion cooperate to define an inflation cavity or chamber for receiving inflation gas from an inflator of an airbag assembly to inflate the airbag cushion. The airbag cushion also includes an inflation gas deflector that is attached or otherwise connected to the base portion of the airbag cushion. The inflation gas deflector comprises a support layer and an inorganic platelet layer that is carried by the support layer. The inflation gas deflector comprises a support layer and an inorganic platelet layer that is carried on a surface of the support layer. According to certain embodiments, the inflation gas detector is positioned between the base portion and the cushioning portion of the airbag cushion. According to certain embodiments the inflation gas detector is attached or connected to an inner surface of the base portion of the airbag cushion. The inflation gas deflector can be attached to the airbag cushion by sewing, stitching, threading, and like methods. In certain embodiments, the inflation gas deflector is sewn to the airbag cushion. In certain embodiments, the inflation gas deflector is sewn to the base portion of the airbag cushion.

According to certain illustrative embodiments, the airbag cushion comprises a base portion having an opening with which an inflator for delivering an inflation gas into the airbag is coupled. The airbag cushion also includes a cushioning portion that is attached to the base portion of the airbag cushion. The base portion and cushioning portion of the airbag cushion cooperate to define an inflation cavity or chamber for receiving inflation gas from an inflator of an airbag assembly to inflate the airbag cushion. The airbag cushion also includes an inflation gas deflector that is attached to the base portion of the airbag cushion. The inflation gas deflector comprises an inorganic platelet layer that is disposed between two support layers. According to certain embodiments, the inflation gas detector is positioned between the base portion and the cushioning portion of the airbag cushion. According to certain embodiments the inflation gas detector is attached or connected to an inner surface of the base portion of the airbag cushion.

According to certain illustrative embodiments, the airbag cushion comprises a base portion having an opening with which an inflator for delivering an inflation gas into the airbag is coupled. The airbag cushion also includes a cushioning portion that is attached to the base portion of the airbag cushion. The base portion and cushioning portion of the airbag cushion cooperate to define an inflation cavity or chamber for receiving inflation gas from an inflator of an airbag assembly to inflate the airbag cushion. The airbag cushion also includes an inflation gas deflector that is attached to the base portion of the airbag cushion and is positioned between the base portion and the cushioning portion of the airbag cushion. The inflation gas deflector comprises an adhesive layer that is carried by a support layer and is disposed between the support layer and an inorganic platelet layer.

According to certain illustrative embodiments, the airbag cushion comprises a base portion having an opening with which an inflator for delivering an inflation gas into the airbag is coupled. The airbag cushion also includes a cushioning portion that is attached to the base portion of the airbag cushion. The base portion and cushioning portion of the airbag cushion cooperate to define an inflation cavity or chamber for receiving inflation gas from an inflator of an airbag assembly to inflate the airbag cushion. The airbag cushion also includes an inflation gas deflector that is attached to the base portion of the airbag cushion. The inflation gas deflector comprises an adhesive layers that are carried by separate support layers. An inorganic platelet layer is positioned between the two adhesive layers that are carried by the support layers. According to certain embodiments, the inflation gas detector is positioned between the base portion and the cushioning portion of the airbag cushion. According to certain embodiments the inflation gas detector is attached or connected to an inner surface of the base portion of the airbag cushion.

The one or more support layer(s) of the inflation gas deflector may comprise a polymer film, a paper, a woven fabric or combinations thereof. According to certain illustrative embodiments the support layer of the inflation gas deflector comprises a woven fabric.

According to certain illustrative embodiments, the one or more support layer(s) comprises a polymer film. The polymer film may be selected from polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, ethylene chlorotrifluoroethylene films and combinations thereof. According to certain embodiments, the polymer film comprises a polyetheretherketone film.

According to other illustrative embodiments, the one or more support layer(s) comprises a paper. The paper comprising the support layer may comprise an inorganic fiber paper, such as a paper containing inorganic fibers and binder. The inorganic fibers may be selected from high alumina polycrystalline fibers, mullite fibers, ceramic fibers, glass fibers, biosoluble fibers, quartz fibers, silica fibers and combinations thereof.

The high alumina polycrystalline fibers comprising the paper support comprise the fiberization product of about 72 to about 100 weight percent alumina and about 0 to about 28 weight percent silica.

The ceramic fibers comprise alumino-silicate fibers comprising the paper support comprise the fiberization product of about 45 to about 75 weight percent alumina and about 25 to about 55 weight percent silica.

The biosoluble fibers may comprise magnesia-silica fibers comprising the paper support comprise the fiberization product of about 65 to about 86 weight percent silica and from about 14 to about 35 weight percent magnesia. The magnesia-silica fibers may comprise the fiberization product of about 70 to about 86 weight percent silica, about 14 to about 30 weight percent magnesia and about 5 weight percent or less impurities. The magnesia-silica fibers may comprise the fiberization product of about 70 to about 80 weight percent silica, about 18 to about 27 weight percent magnesia and 0 to 4 weight percent impurities. Suitable magnesia-silica fibers are commercially available from Unifrax I LLC (Tonawanda, N.Y., USA) under the registered trademark ISOFRAX.

The biosoluble fibers comprise calcia-magnesia-silica fibers comprising the paper support may comprise the fiberization product of about 45 to about 90 weight percent silica, greater than 0 to about 45 weight percent calcia, and greater than 0 to about 35 weight percent magnesia. The calcia-magnesia-silica fibers may comprise the fiberization product of about 60 to about 70 weight percent silica, from about 16 to about 35 weight percent calcia, and from about 4 to about 19 weight percent magnesia. The calcia-magnesia-silica fibers may comprise the fiberization product of about 61 to about 67 weight percent silica, from about 27 to about 33 weight percent calcia, and from about 2 to about 7 weight percent magnesia. Suitable calcia-magnesia-silica fibers are commercially available from Unifrax I LLC (Tonawanda, N.Y., USA) under the registered trademark INSULFRAX.

The binder that may be included in the inorganic fiber paper may comprise an organic binder selected from acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, unsaturated polyesters, epoxy resins, polyvinyl esters and combinations thereof. According to other embodiments, the binder included in the inorganic fiber paper may comprise an inorganic binder. The inorganic binder may be selected from colloidal alumina, colloidal silica, colloidal zirconia and combinations thereof. The binder may include a blend of organic binder and inorganic binder. The binder may include a blend of more than one type of organic binder and one type of inorganic binder. The binder may include one type of organic binder and more than one type of inorganic binder. The binder may include a blend of more than one type of organic binder and more than one type of inorganic binder.

The one or more support layer(s) of the inflation gas deflector may comprise a woven fabric. The fibers of the woven fabric may comprise inorganic fibers, organic fibers, or a combination of inorganic and organic fibers. The inorganic fibers may be selected from carbon fibers and glass fibers. The organic fibers may be selected from polyolefin fibers, polyester fibers, polyamide fibers and combinations thereof. According to certain embodiments, the fibers of the woven fabric are polyamide fibers. According to other embodiments, the woven fabric is coated or impregnated with a silicone coating. According to further embodiments, the woven fabric comprises polyamide fibers and the fabric is impregnated with a silicone coating or having at least one surface of the woven fabric coated with a silicone coating.

The inorganic platelet material of the inorganic platelet layer of the gas inflation deflector may be selected from vermiculite, mica, clay, talc platelets and combinations thereof. According to certain embodiments, the inorganic platelets comprise vermiculite platelets. According to certain embodiments, the inorganic platelets comprise mica platelets. According to certain embodiments, the inorganic platelets comprise clay platelets. According to certain embodiments, the inorganic platelets comprise a blend of vermiculite and mica platelets. The inorganic platelet material of the inorganic platelet layer may comprise coated platelets. The inorganic platelet layer may include an inorganic pigment material. Without limitation, and only by way of illustration, the inorganic pigment material may include titanium dioxide, iron oxide, chromium oxide, tin oxide, silicon oxide, cobalt oxide, antimony oxide and combinations thereof.

The vermiculite or mica platelets that may be used to prepare the inorganic platelet layer of the inflation gas deflector may be exfoliated. By exfoliation, it is meant that the vermiculite or mica platelets are chemically or thermally expanded. According to other illustrative embodiments, the vermiculite or mica platelets may be exfoliated and defoliated. By defoliation, it is meant that the exfoliated vermiculite or mica platelets are processed in order to reduce the vermiculite or mica to substantially a platelet form.

Suitable mica material that may be used as the inorganic platelets in the inorganic platelet layer of the inflation gas deflector may include, without limitation, muscovite, phlogopite, biotite, lepidolite, glauconite, paragonite and zinnwaldite, and may include synthetic micas such as fluorophlogopite.

Suitable platelet clay material that may be used as the inorganic platelets in the inorganic platelet layer of the inflation gas deflector may include, without limitation, ball clay, bentonite, smectite, hectorite, kaolinite, montmorillonite, saponite, sepiolite, sauconite, or combinations thereof.

While any size inorganic platelet material may be used, inorganic platelet materials with larger relative diameters and high diameter to thickness aspect ratios may be desirable due to their gas impermeability, as well as other properties such as flexibility and processibility. In certain embodiments, the inorganic platelet material may have a diameter of from about 20 μm to about 300 μm. In further embodiments, the inorganic platelet material may have a diameter of from about 40 μm to about 200 μm. In certain embodiments, the inorganic platelet material may have an aspect ratio of from about 50:1 to about 2000:1. In certain embodiments, the inorganic platelet material may have an aspect ratio of from about 50:1 to about 1000:1. In further embodiments, the inorganic platelet material may have an aspect ratio of from about 200:1 to about 800:1.

The inorganic platelet layer of the inflation gas deflector composite may comprise platelets in an amount from about 20 to about 100 weight percent.

The inorganic platelet layer of the inflation gas deflector composite may comprise platelets in an amount of at least 20 weight percent.

The inorganic platelet layer of the inflation gas deflector composite may comprise platelets in an amount of at least 30 weight percent.

The inorganic platelet layer of the inflation gas deflector composite may comprise platelets in an amount of at least 40 weight percent.

The inorganic platelet layer of the inflation gas deflector composite may comprise platelets in an amount of at least 50 weight percent.

The inorganic platelet layer of the inflation gas deflector composite may comprise platelets in an amount of at least 60 weight percent.

The inorganic platelet layer of the inflation gas deflector composite may comprise platelets in an amount of at least 70 weight percent.

The inorganic platelet layer of the inflation gas deflector composite may comprise platelets in an amount of at least 80 weight percent.

The inorganic platelet layer of the inflation gas deflector composite may comprise platelets in an amount of at least 85 weight percent.

The inorganic platelet layer of the inflation gas deflector composite may comprise platelets in an amount of at least 90 weight percent.

The inorganic platelet layer of the inflation gas deflector composite may comprise platelets in an amount of at least 95 weight percent.

The inorganic platelet layer of the inflation gas deflector composite may comprise platelets in an amount of at least 99 weight percent.

The inorganic platelet layer of the inflation gas deflector composite may comprise platelets in an amount of 100 weight percent.

The inorganic platelet layer of the inflation gas deflector composite may comprise mica platelets in an amount of at least 20 weight percent.

The inorganic platelet layer of the inflation gas deflector composite may comprise mica platelets in an amount of at least 30 weight percent.

The inorganic platelet layer of the inflation gas deflector composite may comprise mica platelets in an amount of at least 40 weight percent.

The inorganic platelet layer of the inflation gas deflector composite may comprise mica platelets in an amount of at least 50 weight percent.

The inorganic platelet layer of the inflation gas deflector composite may comprise mica platelets in an amount of at least 60 weight percent.

The inorganic platelet layer of the inflation gas deflector composite may comprise mica platelets in an amount of at least 70 weight percent.

The inorganic platelet layer of the inflation gas deflector composite may comprise mica platelets in an amount of at least 80 weight percent.

The inorganic platelet layer of the inflation gas deflector composite may comprise mica platelets in an amount of at least 85 weight percent.

The inorganic platelet layer of the inflation gas deflector composite may comprise mica platelets in an amount of at least 90 weight percent.

The inorganic platelet layer of the inflation gas deflector composite may comprise mica platelets in an amount of at least 95 weight percent.

The inorganic platelet layer of the inflation gas deflector composite may comprise mica platelets in an amount of at least 99 weight percent.

The inorganic platelet layer of the inflation gas deflector composite may comprise mica platelets in an amount of 100 weight percent.

The inorganic platelet layer of the inflation gas deflector composite may comprise vermiculite platelets in an amount of at least 20 weight percent.

The inorganic platelet layer of the inflation gas deflector composite may comprise vermiculite platelets in an amount of at least 30 weight percent.

The inorganic platelet layer of the inflation gas deflector composite may comprise vermiculite platelets in an amount of at least 40 weight percent.

The inorganic platelet layer of the inflation gas deflector composite may comprise vermiculite platelets in an amount of at least 50 weight percent.

The inorganic platelet layer of the inflation gas deflector composite may comprise vermiculite platelets in an amount of at least 60 weight percent.

The inorganic platelet layer of the inflation gas deflector composite may comprise vermiculite platelets in an amount of at least 70 weight percent.

The inorganic platelet layer of the inflation gas deflector composite may comprise vermiculite platelets in an amount of at least 80 weight percent.

The inorganic platelet layer of the inflation gas deflector composite may comprise vermiculite platelets in an amount of at least 85 weight percent.

The inorganic platelet layer of the inflation gas deflector composite may comprise vermiculite platelets in an amount of at least 90 weight percent.

The inorganic platelet layer of the inflation gas deflector composite may comprise vermiculite platelets in an amount of at least 95 weight percent.

The inorganic platelet layer of the inflation gas deflector composite may comprise vermiculite platelets in an amount of at least 99 weight percent.

The inorganic platelet layer of the inflation gas deflector composite may comprise vermiculite platelets in an amount of 100 weight percent.

The inorganic platelet layer of the inflation gas deflector composite may comprise a blend of mica and vermiculite platelets in an amount of at least 20 weight percent.

The inorganic platelet layer of the inflation gas deflector composite may comprise a blend of mica and vermiculite platelets in an amount of at least 30 weight percent.

The inorganic platelet layer of the inflation gas deflector composite may comprise a blend of mica and vermiculite platelets in an amount of at least 40 weight percent.

The inorganic platelet layer of the inflation gas deflector composite may comprise a blend of mica and vermiculite platelets in an amount of at least 50 weight percent.

The inorganic platelet layer of the inflation gas deflector composite may comprise a blend of mica and vermiculite platelets in an amount of at least 60 weight percent.

The inorganic platelet layer of the inflation gas deflector composite may comprise a blend of mica and vermiculite platelets in an amount of at least 70 weight percent.

The inorganic platelet layer of the inflation gas deflector composite may comprise a blend of mica and vermiculite platelets in an amount of at least 80 weight percent.

The inorganic platelet layer of the inflation gas deflector composite may comprise a blend of mica and vermiculite platelets in an amount of at least 85 weight percent.

The inorganic platelet layer of the inflation gas deflector composite may comprise a blend of mica and vermiculite platelets in an amount of at least 90 weight percent.

The inorganic platelet layer of the inflation gas deflector composite may comprise a blend of mica and vermiculite platelets in an amount of at least 95 weight percent.

The inorganic platelet layer of the inflation gas deflector composite may comprise a blend of mica and vermiculite platelets in an amount of at least 99 weight percent.

The inorganic platelet layer of the inflation gas deflector composite may comprise a blend of mica and vermiculite platelets in an amount of 100 weight percent.

In certain embodiments, the inorganic platelet layer of the inflation gas deflector may comprise from about 20 to about 100 percent by weight of inorganic platelets and from 0 to about 80 percent by weight of binder. In certain embodiments, the inorganic platelet layer of the inflation gas deflector may comprise from about 30 to about 100 percent by weight of inorganic platelets and from 0 to about 70 percent by weight of binder. In certain embodiments, the inorganic platelet layer of the inflation gas deflector may comprise from about 40 to about 100 percent by weight of inorganic platelets and from 0 to about 60 percent by weight of binder. In certain embodiments, the inorganic platelet layer of the inflation gas deflector may comprise from about 50 to about 100 percent by weight of inorganic platelets and from 0 to about 50 percent by weight of binder. In certain embodiments, the inorganic platelet layer of the inflation gas deflector may comprise from about 60 to about 100 percent by weight of inorganic platelets and from 0 to about 40 percent by weight of binder. In certain embodiments, the inorganic platelet layer of the inflation gas deflector may comprise from about 70 to about 100 percent by weight of inorganic platelets and from 0 to about 30 percent by weight of binder. In certain embodiments, the inorganic platelet layer of the inflation gas deflector may comprise from about 80 to about 100 percent by weight of inorganic platelets and from 0 to about 20 percent by weight of binder. In certain embodiments, the inorganic platelet layer of the inflation gas deflector may comprise from about 20 to about 100 percent by weight of inorganic platelets, from 0 to about 40 percent by weight of binder, and from 0 to about 50 percent by weight of a functional filler.

In certain embodiments, the inorganic platelet layer of the inflation gas deflector may comprise from about 50 to about 100 percent by weight of inorganic platelets, from 0 to about 30 percent by weight of binder, and from 0 to about 20 percent by weight of a functional filler.

In certain embodiments, the inorganic platelet layer of the inflation gas detector may comprises from about 60 to about 100 percent by weight of said inorganic platelets, from 0 to about 20 percent by weight of a binder, and from 0 to about 20 percent by weight of a functional filler.

In certain embodiments, the inorganic platelet layer of the inflation gas deflector may comprise from about 20 to about 100 percent by weight of mica platelets, from 0 to about 40 percent by weight of binder, and from 0 to about 50 percent by weight of a functional filler.

In certain embodiments, the inorganic platelet layer of the inflation gas deflector may comprise from about 50 to about 100 percent by weight of mica platelets, from 0 to about 30 percent by weight of binder, and from 0 to about 20 percent by weight of a functional filler.

In certain embodiments, the inorganic platelet layer of the inflation gas detector may comprises from about 60 to about 100 percent by weight of said mica platelets, from 0 to about 20 percent by weight of a binder, and from 0 to about 20 percent by weight of a functional filler.

In certain embodiments, the inorganic platelet layer of the inflation gas deflector may comprise from about 20 to about 100 percent by weight of vermiculite platelets, from 0 to about 40 percent by weight of binder, and from 0 to about 50 percent by weight of a functional filler.

In certain embodiments, the inorganic platelet layer of the inflation gas deflector may comprise from about 50 to about 100 percent by weight of vermiculite platelets, from 0 to about 30 percent by weight of binder, and from 0 to about 20 percent by weight of a functional filler.

In certain embodiments, the inorganic platelet layer of the inflation gas detector may comprises from about 60 to about 100 percent by weight of said vermiculite platelets, from 0 to about 20 percent by weight of a binder, and from 0 to about 20 percent by weight of a functional filler.

In certain embodiments, the inorganic platelet layer of the inflation gas deflector may comprise from about 20 to about 100 percent by weight of a blend of mica and vermiculite platelets, from 0 to about 40 percent by weight of binder, and from 0 to about 50 percent by weight of a functional filler.

In certain embodiments, the inorganic platelet layer of the inflation gas deflector may comprise from about 50 to about 100 percent by weight of a blend mica and vermiculite platelets, from 0 to about 30 percent by weight of binder, and from 0 to about 20 percent by weight of a functional filler.

In certain embodiments, the inorganic platelet layer of the inflation gas detector may comprises from about 60 to about 100 percent by weight of said a blend of mica and vermiculite platelets, from 0 to about 20 percent by weight of a binder, and from 0 to about 20 percent by weight of a functional filler.

The inorganic platelet layer of the inflation gas deflector may include inorganic platelets and an organic and/or inorganic binder. The binder may include a blend of more than one type of organic binder and one type of inorganic binder. The binder may include one type of organic binder and more than one type of inorganic binder. The binder may include a blend of more than one type of organic binder and more than one type of inorganic binder. The organic binder that may be included in the inorganic platelet layer may comprise an organic binder selected from acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, unsaturated polyesters, epoxy resins, polyvinyl esters and combinations thereof. The inorganic binder may comprise a single type of inorganic binder or a blend of more than one type of inorganic binder. Without limitation, suitable inorganic binders that may be included in inorganic platelet layer of the inflation gas deflector include colloidal alumina, colloidal silica, colloidal zirconia, and mixtures thereof.

The inorganic platelet layer of the inflation gas deflector may include mica platelets and an inorganic binder. The inorganic binder may comprise a single type of inorganic binder or a blend of more than one type of inorganic binder. Without limitation, suitable inorganic binders that may be included in inorganic platelet layer of the inflation gas deflector include colloidal alumina, colloidal silica, colloidal zirconia, and mixtures thereof.

The inorganic platelet layer of the inflation gas deflector may include vermiculite platelets and an inorganic binder. The inorganic binder may comprise a single type of inorganic binder or a blend of more than one type of inorganic binder. Without limitation, suitable inorganic binders that may be included in inorganic platelet layer of the inflation gas deflector include colloidal alumina, colloidal silica, colloidal zirconia, and mixtures thereof.

The inorganic platelet layer of the inflation gas deflector may include a blend of mica and vermiculite platelets and an inorganic binder. The inorganic binder may comprise a single type of inorganic binder or a blend of more than one type of inorganic binder. Without limitation, suitable inorganic binders that may be included in inorganic platelet layer of the inflation gas deflector include colloidal alumina, colloidal silica, colloidal zirconia, and mixtures thereof.

The inorganic platelet layer of the inflation gas deflector may include inorganic platelets and an organic binder. The organic binder may comprise a single type of organic binder or a blend of more than one type of organic binder. The organic binder(s) may be provided as a solid, a liquid, a solution, a dispersion, a latex, or similar form. Examples of suitable organic binders that may be included in the inorganic platelet layer include, but are not limited to, acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, organic silicones, organofunctional silanes, unsaturated polyesters, epoxy resins, polyvinyl esters (such as polyvinylacetate or polyvinylbutyrate latexes) and the like. According to certain embodiments, the organic binder included in the inorganic platelet layer of the inflation gas deflector comprises a silicone binder.

The inorganic platelet layer of the inflation gas deflector may include mica platelets and at least one organic binder.

The inorganic platelet layer of the inflation gas deflector may vermiculite platelets and at least one organic binder.

The inorganic platelet layer of the inflation gas deflector may include a blend of mica and vermiculite platelets and at least one organic binder.

The inorganic platelets may be added to the support layer in an amount of about 25 gsm to about 500 gsm. According to certain embodiments, the inorganic platelets may be added to the support layer in an amount of about 30 gsm to about 400 gsm. According to other embodiments, the inorganic platelets may be added to the support layer in an amount of about 40 gsm to about 300 gsm.

Solvents for the binders, if needed, can include water or a suitable organic solvent, such as acetone, for the binder utilized. Solution strength of the binder in the solvent (if used) can be determined by conventional methods based on the binder loading desired and the workability of the binder system (viscosity, solids content, etc.).

According to certain embodiments, the inflation gas deflector comprises a multiple layer composite comprising a support layer comprising a woven fabric of polyamide fibers and an inorganic platelet layer carried by the polyamide fiber woven fabric. The inorganic platelets may be impregnated into the polyamide fiber woven fabric, carried on one or both surfaces of the fabric, or impregnated into the polyamide fiber woven fabric and carried on one or both surfaces of the fabric. According to further embodiments, the polyamide fiber woven fabric is impregnated with a silicone coating or has at least a portion of at least one surface of the polyamide fiber woven fabric coated with a silicone coating.

According to certain embodiments, the inflation gas deflector comprises multiple layer composite comprising polyamide fiber woven fabric support layer that has been impregnated or coated with a silicone, and a mica platelet layer carried by the polyamide fiber woven fabric support layer. The mica platelets may be impregnated into the polyamide fiber woven fabric, carried on one or both surfaces of the fabric, or impregnated into the polyamide fiber woven fabric and carried on one or both surfaces of the fabric.

According to certain embodiments, the inflation gas deflector comprises a multiple layer composite comprising polyamide fiber woven fabric support layer that has been impregnated or coated with a silicone, and a vermiculite platelet layer carried by the polyamide fiber woven fabric support layer. The vermiculite platelets may be impregnated into the polyamide fiber woven fabric, carried on one or both surfaces of the fabric, or impregnated into the polyamide fiber woven fabric and carried on one or both surfaces of the fabric.

According to certain embodiments, the inflation gas deflector comprises a multiple layer composite comprising polyamide fiber woven fabric support layer that has been impregnated or coated with a silicone, and platelet layer comprising a blend of mica and vermiculite platelets carried by the polyamide fiber woven fabric support layer. The blend of mica and vermiculite platelets may be impregnated into the polyamide fiber woven fabric, carried on one or both surfaces of the fabric, or impregnated into the polyamide fiber woven fabric and carried on one or both surfaces of the fabric.

According to certain embodiments, the inflation gas deflector comprises a multiple layer composite comprising polyamide fiber woven fabric support layer that has been impregnated or coated with a silicone, and a platelet layer comprising mica platelets and a binder carried by the polyamide fiber woven fabric support layer. According to certain embodiments, the binder of the platelet layer comprises a silicone binder. The mica platelets may be impregnated into the polyamide fiber woven fabric, carried on one or both surfaces of the fabric, or impregnated into the polyamide fiber woven fabric and carried on one or both surfaces of the fabric.

According to certain embodiments, the inflation gas deflector comprises a multiple layer composite comprising polyamide fiber woven fabric support layer that has been impregnated or coated with a silicone polymer, and a platelet layer comprising vermiculite platelets and a binder carried by the polyamide fiber woven fabric support layer. According to certain embodiments, the binder of the platelet layer comprises a silicone binder. The vermiculite platelets may be impregnated into the polyamide fiber woven fabric, carried on one or both surfaces of the fabric, or impregnated into the polyamide fiber woven fabric and carried on one or both surfaces of the fabric.

According to certain embodiments, the inflation gas deflector comprises a multiple layer composite comprising polyamide fiber woven fabric support layer that has been impregnated or coated with a silicone polymer, and platelet layer comprising a blend of mica and vermiculite platelets and a binder carried by the polyamide fiber woven fabric support layer. According to certain embodiments, the binder of the platelet layer comprises a silicone binder. The blend of mica and vermiculite platelets may be impregnated into the polyamide fiber woven fabric, carried on one or both surfaces of the fabric, or impregnated into the polyamide fiber woven fabric and carried on one or both surfaces of the fabric.

According to certain embodiments, the inflation gas deflector comprises a multiple layer composite comprising a multiple support layers comprising woven fabrics of polyamide fibers and an inorganic platelet layer positioned between the polyamide fiber woven fabric support layers. According to further embodiments, the polyamide fiber woven fabrics are impregnated with a silicone coating or has at least a portion of at least one surface of the polyamide fiber woven fabrics coated with a silicone coating.

According to certain embodiments, the inflation gas deflector comprises a multiple layer composite comprising multiple polyamide fiber woven fabric support layers that have been impregnated or coated with a silicone, and a mica platelet layer positioned between the polyamide fiber woven fabric support layers.

According to certain embodiments, the inflation gas deflector comprises a multiple layer composite comprising multiple polyamide fiber woven fabric support layers that have been impregnated or coated with a silicone, and a vermiculite platelet layer positioned between the polyamide fiber woven fabric support layers.

According to certain embodiments, the inflation gas deflector comprises a multiple layer composite comprising multiple polyamide fiber woven fabric support layers that have been impregnated or coated with a silicone, and a platelet layer comprising a blend of mica and vermiculite platelets positioned between the polyamide fiber woven fabric support layers.

According to certain embodiments, the inflation gas deflector comprises a multiple layer composite comprising multiple polyamide fiber woven fabric support layers that have been impregnated or coated with a silicone, and a platelet layer comprises mica platelets and a binder positioned between the polyamide fiber woven fabric support layers. According to certain embodiments, the binder comprises a silicone binder.

According to certain embodiments, the inflation gas deflector comprises a multiple layer composite comprising multiple polyamide fiber woven fabric support layers that have been impregnated or coated with a silicone, and a platelet layer comprising vermiculite platelets and a binder positioned between the polyamide fiber woven fabric support layers. According to certain embodiments, the binder comprises a silicone binder.

According to certain embodiments, the inflation gas deflector comprises a multiple layer composite comprising multiple polyamide fiber woven fabric support layers that have been impregnated or coated with a silicone, and a platelet layer comprising a blend of mica and vermiculite platelets and a binder positioned between the polyamide fiber woven fabric support layers. According to certain embodiments, the binder comprises a silicone binder.

Also disclosed is an airbag assembly comprising the inflatable airbag cushion of any of the embodiments disclosed above and an inflator for providing inflation gas to the inflatable airbag cushion to inflate the airbag cushion during deployment. The inflator is coupled to the airbag cushion or is otherwise in fluid communication with the cavity of the inflatable airbag cushion, and has at least one inflation gas exit port for permitting the passage of inflation gas from the inflator to the cavity of the inflatable airbag cushion.

The inflator of the airbag assembly includes a source of inflation gas for inflating the inflatable airbag cushion. According to certain embodiments, the source of inflation gas for inflating the airbag cushion comprises at least one container or vessel of pressurized inert gas. According to other embodiments, the source of inflation gas for inflating the airbag cushion comprises at least one source of an ignitable solid chemical propellant. For embodiments that include an ignitable solid chemical propellant as the source of inflation gas for the airbag cushion, the inflator further includes a pyrotechnic ignitor or initiator for initiating the pyrotechnic reaction to convert the solid chemical propellant into an inflation gas for inflating the airbag cushion. According to other embodiments, the inflator is a hybrid inflator having a vessel of a first inflation gas comprising pressurized inert gas and a source of solid chemical propellant for generating a second inflation gas.

The airbag assembly further includes a housing that is configured to be mounted to a vehicle. The inflator of the airbag assembly is coupled or mounted to the housing. The airbag cushion is either folded or rolled up and is packaged within the housing. The housing has a cover member that opens upon activation of the airbag assembly to deploy the inflating airbag toward the occupant of the vehicle.

In certain embodiments, the inorganic platelet layer is directly or indirectly coated onto the support layer, into the support layer, or into and onto the support layer. By indirectly coating, it is meant that the inorganic platelet layer may be coated onto a carrier layer, and the carrier layer engaged with the support layer with the inorganic layer disposed between the carrier layer and the support layer. The carrier layer can then be removed leaving a multiple layer composite comprising the inorganic platelet layer on the support layer.

The inorganic platelet layer may be directly coated unto a support layer, for example, without limitation, by roll or reverse roll coating, gravure or reverse gravure coating, transfer coating, spray coating, brush coating, dip coating, tape casting, doctor blading, slot-die coating, or deposition coating. In certain embodiments, the fire inorganic platelet layer is coated onto the support layer as a slurry of the ingredients in a solvent, such as water, and is allowed to dry. The inorganic platelet layer may be created as a single layer or coating, thus utilizing a single pass, or may be created by utilizing multiple passes, layers or coatings. By utilizing multiple passes, the potential for formation of defects in the inorganic platelet layer is reduced. If multiple passes are desired, the second and possible subsequent passes may be formed onto the first pass while the first pass is still substantially wet, i.e. prior to drying, such that the first and subsequent passes are able to form a single unitary layer upon drying.

When multiple passes, layers or coatings of the inorganic platelet layer are utilized, it is possible to vary the amounts of the ingredients in each pass, layer or coating, such that the passes, layers or coatings may have different amounts of, for example, inorganic platelet material. In certain embodiments, at least one pass, a layer or coating having a greater amount of inorganic platelet material. Alternatively, in certain embodiments another pass, layer or coating may have a greater amount of functional filler in order to reduce the amount of defects present in the pass, layer or coating, and may have a greater ability to correct defects present in a previous pass, layer or coating.

In certain embodiments, the inorganic platelet layer may be directly or indirectly coated onto a first polymeric film, such as but not limited to polyesters, polyimides, polyetherketones, polyetheretherketones, polyvinylfluorides, polyamides, polytetrafluoroethylenes, polyaryl sulfones, polyester amides, polyester imides, polyethersulfones, polyphenylene sulfides, ethylene chlorotrifluoroethylene, combinations thereof, and the like. Commercially available examples of these films are films sold by E.I. DuPont de Nemours & Co. of Wilmington, Del., such as a polyester film sold under the trade designation MYLAR®, a polyvinylfluoride film sold under the trade designation TEDLAR®, and a polyimide film sold under the trade designation KAPTON®, a polyetheretherketone film sold under the trade designation APTIV® by Victrex, plc of Lancashire, UK, a polyetheretherketone film sold under the trade designation KETASPIRE® and an ethylene chlorotrifluoroethylene film sold under the trade designation HALAR® by Solvay SA of Brussels, Belgium, and the like.

Additionally, disclosed is an airbag assembly that includes an inflatable airbag cushion having inflatable cavity or chamber for receiving an inflation gas, the inflation gas deflector of any of the embodiments disclosed herein, and an inflator that is in fluid communication with the cavity or chamber of the airbag cushion and that is configured to deliver or otherwise provide an inflation gas to the inflatable cavity of the airbag cushion. The inflator has at least one gas exit port that is in fluid communication with the inflatable cavity of the airbag cushion. According to certain embodiments, the inflator has more than one gas exit port that is in fluid communication with the inflatable cavity of the airbag cushion.

For embodiments where the inflation gas comprises an ignitable solid chemical propellant, the inflator further includes a pyrotechnic initiator or ignitor for initiating the conversion of the solid chemical propellant, such as sodium azide, into an inert inflation gas to inflate the airbag cushion. According to certain embodiments, the inflator includes a hybrid system for providing an inflation gas to the cavity of the airbag cushion, the hybrid system including a source of pressurized inert gas and a source of solid chemical propellant that is converted to an inflation gas. Both inflation gases are transferred from the inflator to the cavity of the airbag to cooperatively inflate the airbag cushion. The inflator also includes a housing for containing the one or more sources of inflation gas. The airbag system further comprises a housing that is configured to be mounted to a vehicle. The airbag cushion is packaged within the housing and, according to certain embodiments, the inflator is coupled to the housing.

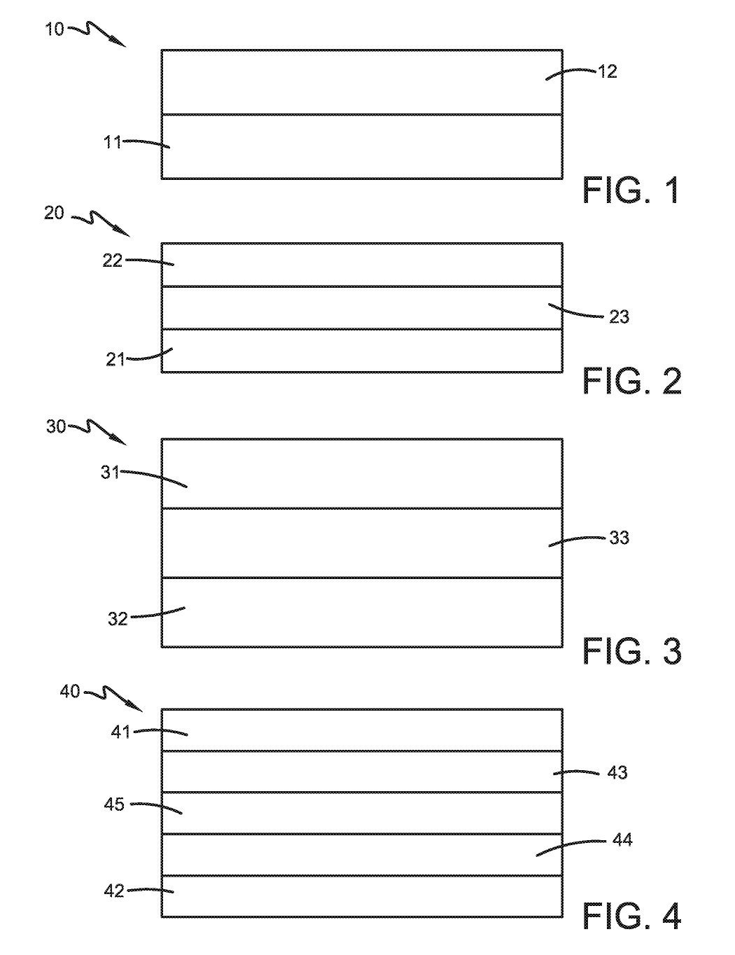

FIG. 1 shows a cross-section of an inflation gas deflector 10. Inflation gas deflector 10 comprises a support layer 11 and an inorganic platelet layer 12 carried by the support layer 11.

FIG. 2 shows a cross-section of an inflation gas deflector 20. Inflation gas deflector 20 comprises a support layer 21 and an inorganic platelet layer 22 carried by the support layer 21. The inflation gas deflector 20 further includes a layer of adhesive 23 positioned between the support layer 21 and the inorganic platelet layer 22.

FIG. 3 shows a cross-section of an inflation gas deflector 30. Inflation gas deflector 30 comprises a first support layer 31 and a second support layer 32. An inorganic platelet layer 33 is positioned between first 31 and second 32 support layers.

FIG. 4 shows a cross-section of an inflation gas deflector 40. Inflation gas deflector 40 comprises a first support layer 41 and a second support layer 42. The inflation gas deflector 40 further includes an inorganic platelet layer 45 positioned between the first 43 and second 44 adhesive layers.

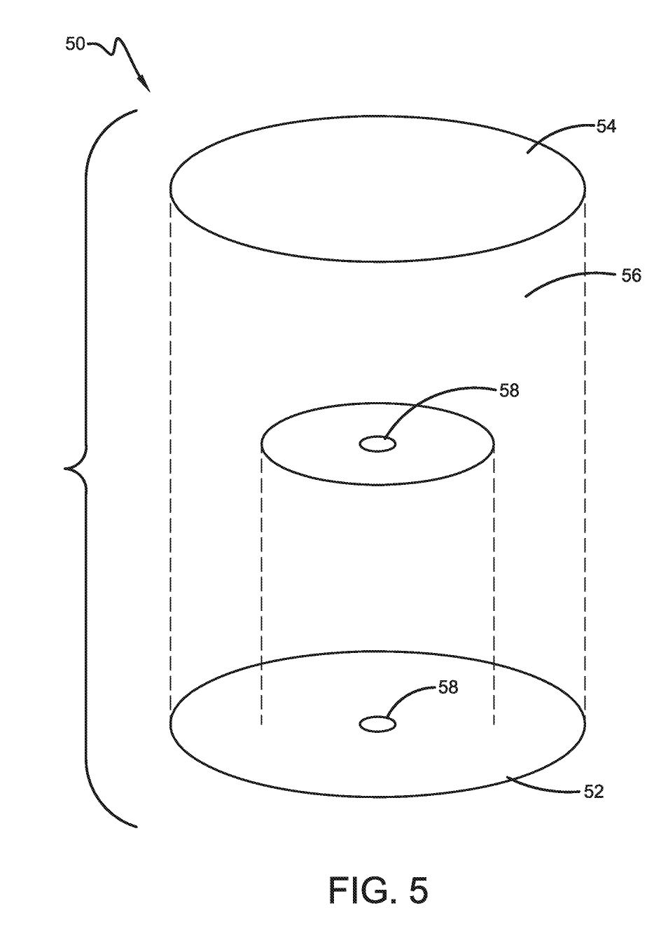

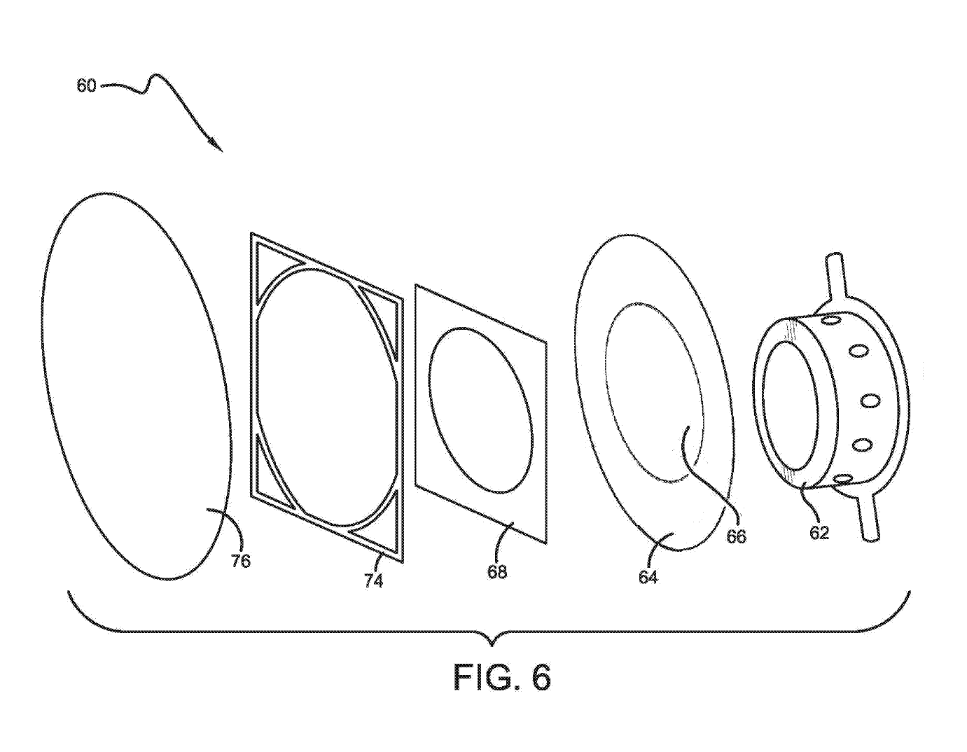

FIG. 5 shows an inflatable airbag cushion 50. Inflatable airbag cushion 50 includes a base portion 52 and a cushioning portion 54. As shown in the illustrative embodiment, base portion 52 and cushioning portion 54 are each substantially circular in shape and have substantially the same size such that their peripheries are substantially coextensive when the cushioning portion 54 is placed on top of the base portion 52. The base 52 and cushioning 54 portions when joined together form an inflation cavity or chamber 56. The joining together of the base 52 and cushioning 54 portions can be accomplished by sewing. The base portion 52 of the airbag cushion 50 further includes an inflator opening 58 that is configured to be coupled with an inflator. The inflator opening 58 may be configured to receive a portion of an inflator. In other embodiments, the inflator opening 58 may be configured to merely be in fluid communication with the inflator, but that the inflator is not physically coupled to the base portion 52 by the inflator opening 58.

FIG. 6 shows an airbag assembly 60 of the present disclosure. Airbag assembly 60 includes an inflator 62. Assembly 60 includes an inflatable airbag comprising a base portion 64 having an inflator opening 66 that is configured to be coupled with a portion of the inflator 62. Positioned on the inner surface of the base portion 64 of the inflatable airbag opposite the outer surface of the base portion 64 facing the inflator 62 is an inflation gas deflector 68. Inflation gas deflector 68 includes an inflator opening 70 configured to be coupled with a portion of the inflator 62. Positioned on the side of the inflation gas deflector 68 opposite the side facing the base portion 64 of the inflatable airbag cushion is frame 74 for affixing the inflation gas deflector 68 and base portion 64 of the inflatable airbag cushion to the inflator unit 62. Inflatable airbag cushion also includes cushioning portion 76. Base portion 64 and cushioning portion 76 of the inflatable airbag are joined together about their outer periphery, such as by sewing, to form an inflatable airbag cushion chamber or cavity.

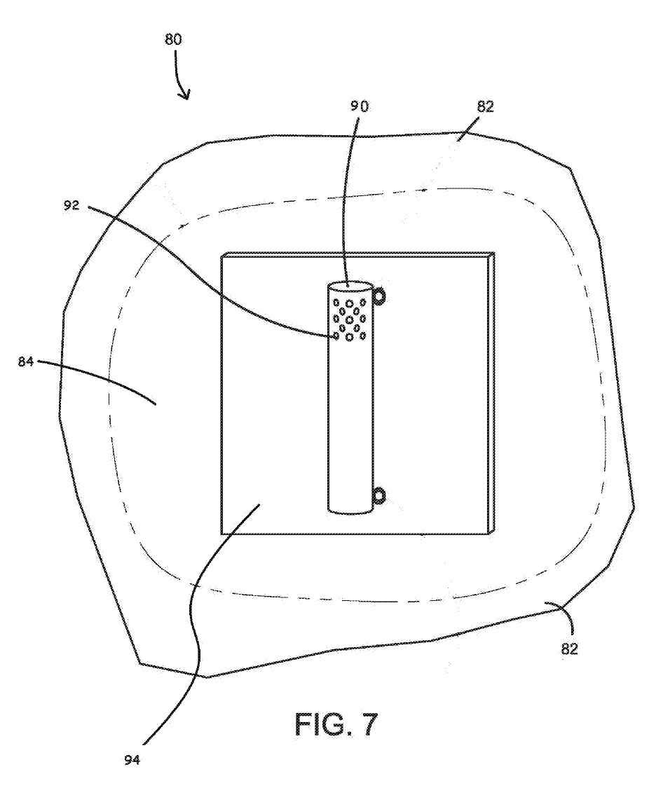

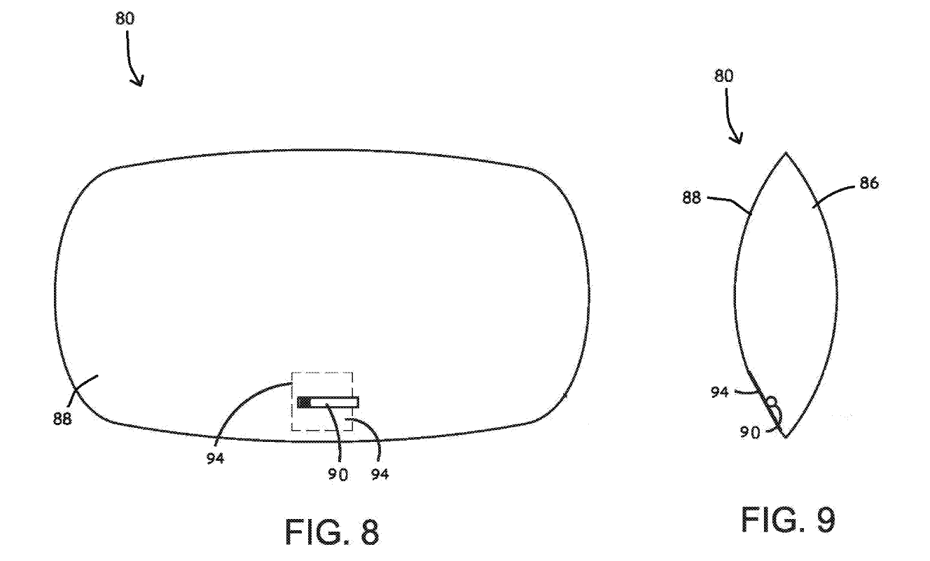

FIGS. 7-9 show various views of an illustrative side curtain airbag assembly 80 of the present disclosure configured for installation in a car door 82. Airbag assembly 80 includes an airbag cushion 84 defining an inflation chamber for receiving an inflation gas. The airbag cushion comprises panels of flexible fabric material 86, 88 of suitable geometry that are joined together about their peripheries. The side curtain air bag assembly includes a suitable inflator 90 for providing inflation gas to the airbag cushion 84 to inflate the inflation chamber. The inflation unit 90 in positioned within the inflation cavity of the airbag cushion 84. The inflation unit 90 is shown as an elongated cylinder or tube structure. The inflation unit contains gas source (not shown) or a material that generates a source of inflation gas. The tubular inflator 90 also includes a plurality of openings 92 configured for passage of inflation gas from the inflator 90 to the inflation cavity of the airbag cushion 84. An inflation gas deflector 94 comprising at least one support layer and at least one inorganic platelet layer carried by the support layer is attached to the inner surface of the airbag cushion 84 to protect the fabric of the airbag cushion 92 from the hot inflation gas provided by the inflator 90. The inflation gas deflector 94 is attached to the inner surface of the airbag cushion 84, such as by sewing a panel of the flexible inflation detector to the inner surface of the airbag cushion 84. The panel comprising the inflation detector 94 is sewn to the airbag cushion 84 between the inner surface of the airbag cushion 84 and the outer surface of the cylindrical inflator 90 so as to shield the inner surface of the airbag cushion 84 from the hot inflation gas generated by or emitted from the inflator 90 in the region of the airbag cushion 84 where the inflator 90 and gas deflector 94 are positioned.

The airbag cushion and automotive airbag assembly described herein may be installed at various locations within a vehicle, including, but not limited to, the steering wheel, the instrument panel, the dashboard, within side doors or side seats, adjacent to roof rails of the vehicle, overhead positions, or at the knee, leg, or lower extremity position. Thus, the term “airbag” as used herein may refer to an inflatable curtain airbag, overhead airbag, front airbag, side airbag, knee airbag, or any other type of airbag that may be installed within a vehicle to protect occupants or passengers from collision or impact injury.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. An airbag cushion comprising:
a cushion portion defining an inflation cavity, and
an inflation gas deflector comprising at least two outer woven layers and at least one inorganic platelet layer between the two outer woven layers.

2. The airbag cushion of claim 1, further comprising a support layer, wherein said at least one inorganic platelet layer is carried by the support layer.

3. The airbag cushion of claim 2, wherein said at least one inorganic platelet layer is carried on both surfaces of said support layer.

4. The airbag cushion of claim 3, wherein said inflation gas deflector further comprises an adhesive layer disposed between said support layer and said inorganic platelet layer.

5. The airbag cushion of claim 1, wherein said at least two outer woven layers comprises a woven fabric comprising fibers selected from the group consisting of polyolefin fibers, polyester fibers, polyamide fibers and combinations thereof.

6. The airbag cushion of claim 5, wherein said woven fabric comprises polyamide fibers.

7. The airbag cushion of claim 1, wherein said at least one inorganic platelet layer comprises inorganic platelets selected from the group consisting of vermiculite, mica, clay, talc and combinations thereof.

8. The airbag cushion of claim 7, wherein said inorganic platelets comprise mica platelets.

9. The airbag cushion of claim 8, wherein said inflation gas deflector comprises at least 20 percent by weight of said mica platelets.

10. The airbag cushion of claim 9, wherein said inflation gas deflector comprises at least 30 percent by weight of said mica platelets.

11. The airbag cushion of claim 10, wherein said inflation gas deflector comprises at least 40 percent by weight of said mica platelets.

12. The airbag cushion of claim 11, wherein said inflation gas deflector comprises at least 50 percent by weight of said mica platelets.

13. The airbag cushion of claim 12, wherein said inflation gas deflector comprises at least 60 percent by weight of said mica platelets.

14. The airbag cushion of claim 13, wherein said inflation gas deflector comprises at least 70 percent by weight of said mica platelets.

15. The airbag cushion of claim 14, wherein said inflation gas deflector comprises at least 80 percent by weight of said mica platelets.

16. The airbag cushion of claim 15, wherein said inflation gas deflector comprises at least 90 percent by weight of said mica platelets.

17. The airbag cushion of claim 8, wherein said inorganic platelets consist of mica platelets.

18. The airbag cushion of claim 1, wherein said at least one inorganic platelet layer comprises a binder.

19. The airbag cushion of claim 18, wherein said inorganic platelet layer of said inflation gas deflector comprises from about 50 to about 100 percent by weight of said mica platelets, from 0 to about 30 percent by weight of said binder.

20. An airbag assembly comprising:
the airbag cushion of claim 1;
an inflation gas deflector attached to said airbag cushion; and
an inflator in communication with said airbag and configured to deliver inflation gas to said airbag cushion.

21. The airbag assembly of claim 20, wherein said inflator comprises at least one of a vessel of pressurized inert gas and/or an ignitable solid chemical propellant.

22. The airbag assembly of claim 20, further comprising a housing configured to be mounted to a vehicle, wherein said inflator is coupled to said housing, wherein said airbag cushion is packaged within said housing.
